(19) United States
(12) Patent Application Publication
(10) Pub. No.: US 2017/0218992 A1
(43) Pub. Date: Aug. 3, 2017

(54) Fastening System

(71) Applicant: Bishop GmbH, Hamburg (DE)

(72) Inventor: Oumarou Sodore, Hamburg (DE)

(21) Appl. No.: 15/183,190

(22) Filed: Jun. 15, 2016

(30) Foreign Application Priority Data
Jan. 28, 2016 (DE) 102016201263.0

(51) Int. Cl. F16B 5/07

(52) U.S. Cl. CPC F16B 5/07

(57) ABSTRACT

The invention relates to a fastening system comprising a first component and a second component. The first component comprises a plurality of fastening projections so that in each case two fastening projections enclose a fastening receiver therebetween. The second component comprises a plurality of fastening projections so that in each case two fastening projections enclose a fastening receiver therebetween. In the connected state of the components the fastening projections of the first component are in engagement with the fastening receivers of the second component and the fastening projections of the second component are in engagement with the fastening receivers of the first component. According to the invention, the fastening projections of the first component are provided with compression slots. The fastening system according to the invention has a high degree of ease of operation and permits stable connections.

### BACKGROUND

The invention relates to a fastening system, a first component and a second component being able to be fastened together thereby. The first component comprises a plurality of fastening projections, wherein in each case two fastening projections enclose a fastening receiver therebetween. The second component also comprises a plurality of fastening projections, wherein in each case two fastening projections enclose a fastening receiver therebetween. In the connected state of the components, the fastening projections of the first component are in engagement with the fastening receivers of the second component and vice versa.

Mechanical connections between two components are used in many technical fields. These include air travel, space travel, automotive, railroad, shipping and construction.

### SUMMARY

The object of the invention is to propose a fastening system in which the components may be easily connected together, whilst at the same time a high strength of the connection is achieved. The object is achieved by the features of claim 1. Advantageous embodiments are disclosed in the subclaims.

According to the invention, the fastening projections of the first component are provided with compression slots. The compression slots according to the invention provide the advantage that the fastening projections may be compressed when the connection is produced, so that the production of the connection is simplified. Thus, in order to produce the connection it is not necessary for the material of the fastening projections to be compressed per se but a deformation takes place in which the compression slot is reduced in size. The material of the fastening projections itself may be sufficiently stable for a stable structure to be produced.

The fastening system according to the invention may be designed such that only one of the components comprises fastening projections with compression slots. It is advantageous if fastening projections with compression slots are provided both in the first component and in the second component.

In order to avoid local stresses when compressing the fastening projections, the end of the compression slot inside the fastening projection may have a rounded shape in cross section. Preferably, viewed in cross section, the compression slot extends with two parallel side walls into the depth of the fastening projection. The two parallel side walls may terminate in a semi-circular shape and may be connected together.

The components may comprise in each case at least five, preferably at least ten, further preferably at least twenty, fastening projections which in each case enclose a corresponding number of fastening receivers therebetween. In the connected state, preferably a corresponding number of fastening projections is in engagement with an opposing fastening receiver.

The fastening projections of the first component are preferably provided with an undercut. The same preferably also applies to the fastening projections of the second component. The undercut means that, relative to the direction of insertion in which the engagement is produced with the opposing fastening receiver, the fastening projection initially has a portion which projects further in the lateral direction, followed by a portion which projects to a lesser extent in the lateral direction. The fastening projection of the other component has to be moved past the wider part in order to be brought into engagement with the fastening receiver. By means of the undercut, the components are prevented from being able to be easily pulled apart from one another. The fastening projections and the fastening receiver are preferably adapted to one another such that the compression slots are not compressed if the two components are connected together.

The undercut is preferably shaped so that the fastening system forms a releasable connection. Embodiments are also encompassed in which the connection is not releasable.

The first component may have a plurality of compression slots which are aligned parallel to one another. The same may apply to the second component. In this case, each fastening projection is preferably provided with just one compression slot. The components may be designed such that they are the only compression slots, i.e. that further compression slots with a different orientation are not provided. The fastening projections may have a greater dimension in the direction of the compression slots than transversely thereto. Relative to this longitudinal direction of the fastening projections, the fastening projections may be arranged parallel to one another. The fastening receivers arranged between the fastening projections may also extend parallel to the fastening projections in the longitudinal direction.

The fastening projections may span a surface along their longitudinal direction and by arranging a plurality of fastening projections in the transverse direction adjacent to one another on the first component. In the transverse direction, therefore, the surface is spanned by alternate fastening projections and fastening receivers. The same may apply to the second component, wherein the surfaces are preferably of the same size. The surface may have, for example, the shape of a rectangle. Depending on the functionality and application, other shapes of the surface are possible.

The fastening projections may be designed such that they have a uniform cross section in the longitudinal direction. The cross section may be symmetrical relative to the center of the compression slot. Viewed in the direction of insertion, the fastening projections may have a wider portion to the front, followed by a narrower portion. The transition from the wider portion to the narrower portion forms the undercut of the fastening projections. The wider portion is at a greater distance from the structure of the component than the narrower portion. The fastening projections of the first component may have an identical cross section to one another. The same may apply to the second component.

The fastening projections of the first component may be designed to be complementary to the fastening receiver of the second component. The fastening projections of the second component may be designed to be complementary to the fastening receiver of the first component. “Complementary” means that the outer surface of a fastening projection of the first component which is inserted into a fastening receiver of the second component bears flat against the outer surfaces of the adjacent fastening projections of the second component. Preferably, the fastening projection of the first component entirely fills up the fastening receiver of the second component so that the compression slot of the fastening projection forms the only hollow space inside the fastening receiver when the components are connected together.

As a result, in cross section the fastening receiver is identical to the associated fastening projections if the compression slot is taken out of consideration. A closed structure may be formed by means of a plurality of such fastening projections and fastening receivers in the transverse direction adjacent to one another, no further hollow spaces being provided therein apart from the compression slots. In particular, this may be implemented if the fastening projections of the first component are identical in cross section to the fastening projections of the second component.

A particularly advantageous ratio between the strength of the connection and the ease of operation is produced when the outer contour of the fastening projection, viewed in cross section, is made up of a plurality of circular segment-shaped portions. A first circular segment with a first radius may be adjoined onto the centrally arranged compression slot, said first circular segment defining a convex portion of the fastening projection. A second circular segment with a second radius may be adjoined onto the first circular segment, said second circular segment also defining the fastening projections in a convex manner. The second radius is preferably larger than the first radius. The second circular segment preferably extends over the widest point of the fastening projection. A third circular segment with a third radius may adjoin the second circular segment, said third circular segment defining a concave portion of the fastening projection. The third radius may be the same as the second radius. A fourth circular segment with a fourth radius may adjoin the third circular segment, wherein the fourth circular segment defines a concave portion of the fastening projection. The fourth radius may be equal to the first radius. The fourth circular segment may extend as far as the center of the adjacent fastening receiver. The contour of the next fastening projection may be adjacent thereto in a mirror-inverted manner. Each individual fastening projection is preferably symmetrical relative to the compression slot.

The contour of the fastening projection may have one or more of the aforementioned circular segments in any combination with one another. A combination of the second and third circular segments is advantageous, in particular, wherein the radius of both circular segments coincide. As a result, the force which has to be applied when joining the components in order to compress the fastening projection is as great as the force required when releasing the components from one another.

Different materials are used for the fastening system according to the invention. In particular, the fastening projections may consist of a metallic material or a non-metallic material.

The fastening system according to the invention may be used in components with a fixed inner structure which do not alter in its shape when the connection is produced. It is a substantial advantage of the invention that it is possible to produce the connection without portions of the component other than the fastening projections having to be deformed. An application comprising components made from a flexible material is also encompassed by the invention.

The fastening projections may be integral components of the component or connected to the component in a suitable manner. It is possible to produce the component in one piece with the fastening projections as an injection-molded part. A production by means of 3D printing may also be advantageous, the undercuts being able to be easily produced thereby in the direction of insertion.

In one embodiment, the one-piece component comprises a support structure, the fastening projections being attached thereto. Means may be provided on the support structure, the support structure being able to be fastened to a further component thereby. In this manner, the fastening system may be used in order to connect any components together.

The fastening system according to the invention has the further advantage that it may be used both in humid conditions and in dry conditions.

### BRIEF DESCRIPTION OF THE DRAWINGS

The invention is described by way of example hereinafter with reference to the accompanying drawings with reference to advantageous embodiments. In the drawings:

FIG. 1 shows a sectional view of a fastening system according to the invention in the separated state;

FIG. 2 shows a sectional view of a fastening system according to the invention in the connected state; and

FIG. 3 shows a detail of FIG. 1 in an enlarged view.

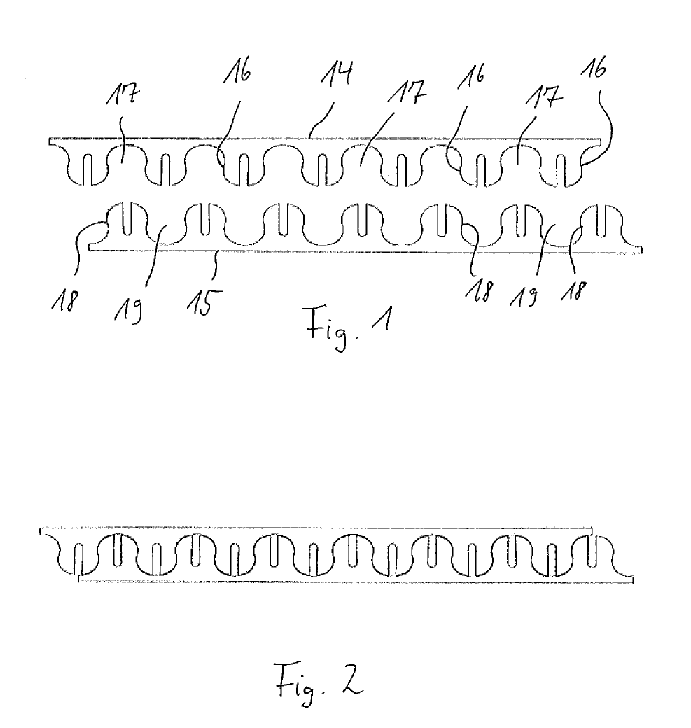

### DETAILED DESCRIPTION

A fastening system shown in FIG. 1 comprises a first component 14 and a second component 15. The first component 14 comprises a plurality of fastening projections 16. A fastening receiver 17 is enclosed between two adjacent fastening projections 16 in each case. Shown in FIG. 1 are seven fastening projections 16 arranged adjacent to one another with six fastening receivers 17 arranged therebetween. The fastening system may comprise more fastening projections 16 and fastening receivers 17 than are shown in FIG. 1.

The fastening projections are shown in FIG. 1 in cross section. The fastening projections 16 extend with a uniform cross section in the longitudinal direction, oriented perpendicular to the sheet plane. The dimension of the fastening projections in the longitudinal direction, for example, may be five times or ten times as great as the width visible in FIG. 1 of the fastening projection. The fastening projections 17 in this manner cover a rectangular surface on the component 14 with a uniformly repeating structure.

Correspondingly, on the surface of the second component 15 a rectangular surface is covered by fastening projections 18 and fastening receivers 19. The shape of the fastening projections 18 and the fastening receivers 19 of the second component 15 are identical to the fastening projections 16 and the fastening receiver 17 of the first component 14. If the first component 14 in FIG. 1 were reflected on a horizontal line and pushed slightly to the side, it would cover the second component 15 in an identical manner.

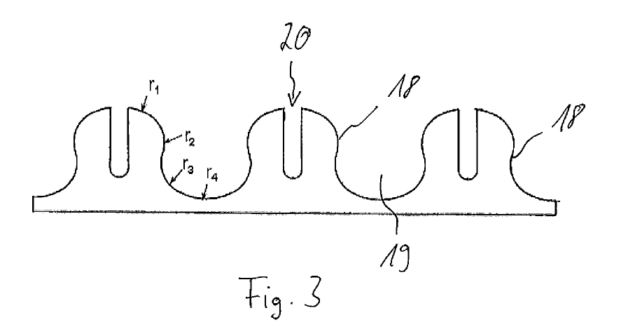

The shape of the fastening projections 18 and the fastening receivers 19 is described in more detail with reference to the enlarged view of FIG. 3. Accordingly, the fastening projections 18 are symmetrical in cross section with a compression slot 20 which is arranged centrally and extends into the depth of the fastening projection 18. At its lower end the compression slot 20 terminates in a semi-circular shaped contour.

A first circular segment-shaped portion r1 with a first radius adjoins the compression slot 20. The first circular segment-shaped portion merges into a second circular segment-shaped portion r2 with a second radius, wherein the radius r2 is smaller than the radius r1. Together, the first and the second circular segment shaped-portion form a convex part of the contour of the fastening projection 18. A concave part of the contour of the fastening projection 18 adjoins this convex part. This is formed from a third circular segment-shaped portion r3, which adjoins directly the second circular segment-shaped portion. The third circular segment-shaped portion r3 has a third radius which is as large as the radius r2. A fourth circular segment-shaped portion r4 adjoins the third circular segment-shaped portion r3, said fourth circular segment-shaped portion having a fourth radius. The radius r4 is as large as the radius r1. The fourth circular segment-shaped portion r4 forms at the same time the center of the adjacent fastening receiver 19.

In this manner, a shape of the fastening projection 18 is produced which is complementary to the fastening receiver 19. If FIG. 3 were to be reflected on the horizontal line which extends through the transition between the second circular segment-shaped portion and the third circular segment-shaped portion and displaced slightly to the side, the fastening projections 18 and the fastening receiver 19 would be covered in an identical manner apart from the compression slots 20.

The widest point of the fastening projection 18 is formed by the second circular segment-shaped portion r2. The second circular segment-shaped portion r2 extends beyond the widest point and thus forms a portion in which the fastening projection 18 tapers again. Relative to the direction of insertion, this tapering forms an undercut which may be engaged from behind by the fastening projections of the other component.

If the components 14, 15 were to be guided together from the position shown in FIG. 1, the fastening projections 16 of the first component 14 would engage in the fastening receiver 19 of the second component 15 and vice versa. The widest point of the fastening projections 16 is slightly wider than the narrowest point of the fastening receiver 19 so that the two may be brought into engagement with one another without resistance. If the two components 14, 15 are pressed together, via the outer surfaces a force is exerted in the transverse direction onto the fastening projections 16, 18, the fastening projections 16, 18 being compressed thereby in the transverse direction.

In this compressed state, the widest points of the fastening projections 16 are able to pass the widest points of the fastening projections 18, so that a full engagement with the respectively opposing fastening receivers 17, 19 is achieved. The fastening projections 16, 18 relax again so that the widest points engage behind one another. The connection between the components 14, 15 may be produced in this manner without regions of the components 14, 15 other than the fastening projections 16, 18 having to be deformed.

In order to separate the two components 14, 15 again from one another, a force is exerted in the opposing direction. As a result, the fastening projections 16, 18 are compressed again, so that the widest points may be overcome. The force expenditure required therefor corresponds substantially to the force expenditure when producing the connection.

1. A fastening system comprising a first component and a second component, wherein the first component comprises a plurality of fastening projections so that in each case two fastening projections enclose a fastening receiver therebetween, wherein the second component comprises a plurality of fastening projections so that in each case two fastening projections enclose a fastening receiver therebetween, and wherein in the connected state of the components the fastening projections of the first component are in engagement with the fastening receivers of the second component and the fastening projections of the second component are in engagement with the fastening receivers of the first component, wherein the fastening projections of the first component are provided with compression slots.

2. The fastening system as claimed in claim 1, wherein the fastening projections of the second component are provided with compression slots.

3. The fastening system as claimed in claim 1, wherein the fastening projections are provided with an undercut relative to the direction of insertion.

4. The fastening system as claimed in claim 1, wherein the connection is releasable.

5. The fastening system as claimed in claim 1, comprising a plurality of fastening projections, the compression slots thereof being aligned parallel to one another.

6. The fastening system as claimed in claim 1, wherein the fastening projections have a uniform cross section relative to a longitudinal direction.

7. The fastening system as claimed in claim 1, wherein the fastening projections of the first component are configured to be complementary to the fastening receivers of the second component.

8. The fastening system as claimed in claim 1, wherein the fastening projections of the first component and the fastening projections of the second component in cross section have an identical shape.

9. The fastening system as claimed in claim 1, wherein the outer contour of the fastening projections, viewed in cross section, is made up of a plurality of circular segment-shaped portions.

10. The fastening system as claimed in claim 10, wherein a convex portion has the same radius as a concave portion.

11. The fastening system as claimed in claim 10, wherein a first convex portion has a different radius from a second convex portion.
